(19) United States
(12) Patent Application Publication
(10) Pub. No.: US 2005/0003112 A1
(43) Pub. Date: Jan. 6, 2005

(54) Inkjet recording materials containing siloxane copolymer surfactants

(76) Inventor: Tienteh Chen, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/613,497

(22) Filed: Jul. 2, 2003

(51) Int. Cl. B41M 5/00

(52) U.S. Cl. 428/32.11

(57) ABSTRACT

A print medium comprising a coated paperbase and an ink-receiving layer. The ink-receiving layer comprises a nonionic siloxane copolymer surfactant. A method of forming the print medium is also disclosed. In addition, a method of printing an image having improved image quality and permanence is disclosed.

### BACKGROUND OF THE INVENTION

Print media that are capable of inkjet printing photographic image quality generally include an ink-receiving layer on a substrate, such as a paperbase or a photobase. The ink-receiving layer includes multiple coatings that are formed from inorganic or organic materials, such as inorganic particles or organic polymers. The print media are typically categorized into two groups: porous media and swellable media. Porous media generally have an ink-receiving layer that is formed from porous, inorganic particles bound with a polymer binder. The inkjet ink is absorbed into the pores of the inorganic particles and the colorant is fixed by mordants incorporated in the ink-receiving layer or by the surface of the inorganic oxides. Porous media have a short dry time and good resistance to smearing because the inkjet ink is easily absorbed into the pores of the ink-receiving layer. However, porous media do not exhibit good resistance to fade, exhibit low color gamut, and exhibit poor lighffastness. In swellable media, the ink-receiving layer is a continuous layer of a swellable, polymer matrix. When the inkjet ink is applied, the inkjet ink is absorbed by swelling of the polymer matrix and the colorant is immobilized inside the continuous layer. Since the colorant is protected from the outside environment, swellable media have greater resistance to light and dark/air fade than the porous media. However, the swellable media generally have reduced smearfastness and a longer drytime than porous media.

To achieve high image quality, photobase papers have typically been used as the substrate in print media instead of paperbase papers. Photobase papers are pulp papers laminated with a polyethylene layer on each side. While photobase papers provide high image quality, they are more expensive than paperbase papers and add to the overall cost of the print media. Furthermore, photobase papers do not readily absorb the ink vehicle used in the inkjet ink. In addition, multiple layers are used as the ink-receiving layer to separate the colorant from the ink vehicle to improve coalescence. Another disadvantage of using photobase papers is that the images printed on these print media have poor bleed and color fastness under humid conditions. Therefore, there is need to improve the performance of conventional, non-absorptive photobase papers.

In contrast, images printed on print media having paperbase papers have good bleed resistance. These paperbase papers include uncoated papers (referred to herein as “plain papers”) and papers having coated, porous surfaces that allow the inkjet ink to be readily absorbed and to dry quickly. However, the paperbases tends to cockle and wrinkle when inkjet ink is printed upon it, which decreases the image quality and glossiness of the printed image. In addition, the color gamut or color saturation of the printed image is typically much lower than that of an image printed on photobase paper.

Numerous print media for printing photographic quality images are known in the art. These print media include an ink-receiving layer having a coating composition that includes a hydrophilic polymer, organic or inorganic particles, a cationic polymer, a hardening agent, and a nonionic, anionic, or cationic surfactant. Some of the coating compositions have been used with photobase while others have been used with paperbase. However, these print media do not exhibit low levels of mottle, haze, humid bleed, humid color shift, and coalescence. In addition, the print media do not provide optimal levels of optical density (“OD”), color gamut, and lighffastness. Although print media that include non-siloxane surfactants have been used with photobase and paperbase media, these media exhibit low color gamut, haze, mottling, and poor coalescence.

It would be desirable to produce a paper-based print medium having photographic image quality. The print medium is desirably low cost and also provides high print quality, high color gamut, high image permanence, and better humid bleed and humid color shift compared to a print medium having a photobase paper. In addition, the images printed on the print medium should have minimal mottle, haze, humid bleed, and humid color shift. The printed images should also have an excellent optical density (“OD”), color gamut, and lighffastness.

### BRIEF SUMMARY OF THE INVENTION

The present invention relates to a print medium comprising an ink-receiving layer and a coated paperbase. The ink-receiving layer comprises a siloxane copolymer surfactant.

The present invention also relates to a method of forming a print medium having improved image quality and permanence. The method comprises providing a coated paperbase. An ink-receiving layer is applied to the coated paperbase. The ink-receiving layer comprises a siloxane copolymer surfactant.

The present invention also relates to a method of printing an image having improved image quality and permanence. The method comprises providing a print medium that includes a coated paperbase and an ink-receiving layer. The image is printed on the print medium. The ink-receiving layer comprises a siloxane copolymer surfactant.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawing in which:

FIG. 1 schematically illustrates a print medium according to an embodiment of the present invention.

### DETAILED DESCRIPTION OF THE INVENTION

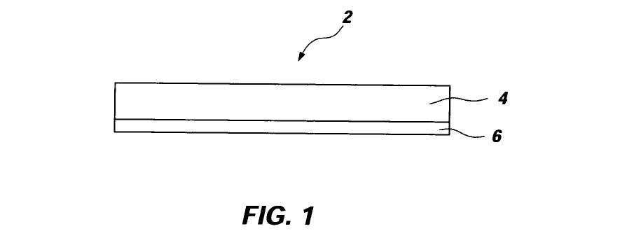

The present invention provides a swellable, print medium that exhibits improved image quality and permanence. The print medium 2 has an ink-receiving layer 4 that is formed over a coated paperbase 6, as illustrated in FIG. 1. The ink-receiving layer 4 includes a siloxane copolymer surfactant and may additionally include at least one hydrophilic or water-soluble polymer, a cross-linking agent, a mordant, inorganic particles, and at least one non-siloxane surfactant. A layer of the ink-receiving layer 4 may be applied to the coated paperbase 6 to form the print medium 2. Images printed on the print medium 2 have improved mottle, haze, color gamut, K_{od}, lighffastness, humid bleed, and humid color shift.

The ink-receiving layer 4 includes a siloxane copolymer surfactant, such as a siloxane-polyethyleneoxide-polypropyleneoxide copolymer or a siloxane-polyethyleneoxide copolymer. The siloxane copolymer surfactants may be prepared by any method known to those having skill in the art and can be prepared as random, alternate, block, or graft copolymers. For example, in one particular embodiment of the invention, the polyethyleneoxide/polypropyleneoxide segment of the surfactant is grafted on the poly(siloxane) backbone. Representative siloxane copolymer surfactants suitable for use in the present invention include surfactants having the following structure: 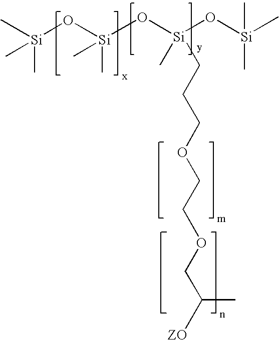
wherein m, n, x, and y are such as to provide a molecular weight greater than about 1000, wherein Z is H, —CH₃, or a C₁ to C₁₀ straight chain or branched primary or secondary hydroxy terminated alkylene group, and wherein the structure contains at least one polyethyleneoxide group.

Other representative siloxane copolymer surfactants suitable for use in the present invention include surfactants having the following structure: 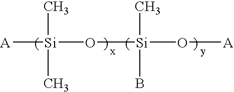
wherein A is —CH₃ or B, and B is a C₁ to C₁₀ straight chain or branched primary or secondary hydroxy terminated alkylene group, and x and y are such as to provide a molecular weight greater than about 1000.

In another embodiment, the surface tension of the siloxane copolymer surfactant is from about 25 dyne/cm to about 35 dyne/cm. In another embodiment, the hydrophilic/hydrophobic balance value (HLB) of the siloxane copolymer surfactant is from about 10 to about 30 and, preferably, from about 12 to about 25. In yet another embodiment of the invention, the weight percent (wt %) of the siloxane copolymer surfactant used in the ink-receiving layer 4 is from about 0.05 wt % to about 2 wt %, and preferably from about 0.05 wt % to about 1 wt % based on the total weight of the ink-receiving layer 4. The siloxane copolymer surfactants of the present invention preferably have a molecular weight of greater than about 1000.

In addition to the siloxane copolymer surfactant, the ink-receiving layer 4 may also include one or more anionic and/or nonionic surfactant(s). When nonionic or anionic surfactants are incorporated into the ink-receiving layer 4, the total amount of nonionic or anionic surfactant used (in relation to the siloxane copolymer surfactant) cannot be more than 50% of the total surfactant concentration. In other words, the ink-receiving layer 4 should contain more siloxane copolymer surfactant than nonionic/anionic surfactant by weight. Nonionic surfactants that may be used include, but are not limited to, ethoxylated alkylphenols, ethoxylated fatty acids and esters, ethoxylated alcohols, an alkoxlyated tetramethyl decyndiol, an alkoxylated trimethylnonanol, a polyoxyethylene ether, and an ethylene oxide/propylene oxide copolymer. Anionic surfactants that may be used include, but are not limited to, alkylaryl sulfonates, diphenylsulfonate derivatives, olefin sulfonates, phosphate esters, sulfates and sulfonates of oils and fatty acids, sulfates or sulfonates of fluorosurfactants, sulfates and sulfonates of ethoxylated alkylphenols, sulfates of alcohols, sulfates of ethoxylates alcohols, sulfates of fatty esters, sulfonates of condensed naphthalenes, sulfonates of dodecyl and tridecylbenzenes, sulfonates of naphthalene and alkyl naphthalene. Preferably, the surfactant is a nonionic organosilicone compound, such as a copolymer of polysiloxane-polyethylene oxide or terpolymer of polysiloxane-polyethylene oxide-poly(propylene oxide), and ethylene oxide/propylene oxide diblock and triblock copolymers. Nonionic siloxane surfactants may be obtained from OSI Specialties (South Charleston, W.Va.) under the tradename Silwet®. Ethylene oxide/propylene oxide diblock and triblock copolymers may be obtained from BASF Corp. under the tradenames Pluronic® F, Pluronic® L, Pluronic® P, Pluronic® R, Tetronic®, or Tetronic® R. Preferably, the nonionic, organosilicone surfactant is a Silwet® compound, such as Silwet® L-7201 or Silwet® L-7605.

The water-soluble polymer may be used to provide fast ink absorption and good image quality, to bind the components of the ink-receiving layer 4 together, and to provide physical strength to the print medium 2. The water-soluble polymer may include, but is not limited to, polyvinyl alcohol (“PVOH”), a copolymer of polyvinylalcohol with polyethyleneoxide, a copolymer of polyvinylalcohol with polyacrylic or maleic acid, acetoacetylated polyvinylalcohol, polyvinylalcohol with quaternary ammonium functional groups, a copolymer of polyvinylalcohol-polyvinylamine, polyvinyl pyrrolidone, a copolymer of polyvinylpyrrolidone with polyvinylacetate, polyacrylamide, polyethylene oxide, hydroxyethyl cellulose, hydroxypropylmethyl cellulose, poly(N-ethyl-2-oxazoline), casein, starch, agar, carrageenan, polymethacrylamide, cellulose, carboxymethyl cellulose, dextran, pullulan, gelatin, a derivative thereof, or a mixture thereof. If a mixture of water-soluble polymers is used, the mixture may include more than one compound from one of these classes of water-soluble polymers or more than one compound from more than one of these classes of water-soluble polymers. The water-soluble polymer(s) may be present in the ink-receiving layer 4 from about 60% to about 90% based on the total weight of the ink-receiving layer 4.

In one particular embodiment of the invention, the at least one water-soluble polymer is PVOH, a modified PVOH, or a mixture of PVOH compounds. The modified PVOH may be formed by cationic or anionic modifications to the end of the PVOH molecule. These PVOH compounds are available from numerous sources, such as Kuraray Specialties Europe GmbH (Frankfurt, Germany) and Nippon Gohsei (Osaka, Japan). The PVOH may be partially or completely saponified and has a saponification ratio of from approximately 70% to approximately 100%. More preferably, the saponification ratio is at least approximately 80%. For optimum coalescence, preferably, a mixture of PVOH compounds having 80-88% hydrolysis is used in the ink-receiving layer 4. If the ink-receiving layer 4 includes more than one compound from more than one class of water-soluble polymers, PVOH may be present as a major component of the mixture. In other words, the PVOH may be present in the mixture from approximately 90% to approximately 95%. For instance, the ink-receiving layer 4 may include PVOH and polyvinyl pyrrolidone.

The inorganic particles used in the ink-receiving layer 4 may have a small particle size and a low index of refraction. The inorganic particles may include, but are not limited to, precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudo boehmite, aluminum hydroxide, lithopone, zeolite, or magnesium hydroxide. The inorganic particles may have a small diameter, such as from approximately 3 nm to approximately 30 nm. The inorganic particles used in the ink-receiving layer may be positively or negatively charged, which is provided by a modification to the surface of the inorganic particles. Preferably, colloidal silica is used in the ink-receiving layer 4. If colloidal silica is used, the charge may be provided by treating the surface of the colloidal silica particles with aluminum, calcium, magnesium, or barium ions. More preferably, a cationic, superfine colloidal silica is used in the ink-receiving layer 4. Cationic, superfine colloidal silica is commercially available from numerous sources, such as Ludox® CL from Grace Davison (Columbia, Md.).

To provide the print medium 2 with improved smudge and water resistance, the cross-linking agent may be used in the ink-receiving layer 4. The cross-linking agent includes a functional group that may react with a functional group on the water-soluble polymer. For instance, when PVOH is used as the water-soluble polymer, the cross-linking agent may include a functional group that reacts with hydroxyl groups on the PVOH. The cross-linking agent may include, but is not limited to, boric acid and salts thereof; an epoxy based agent, such as diglycidyl ethyl ether, ethylene glycol diglycidyl ether, 1,4-butanediol diglycidyl ether, 1,6-diglycidylcyclohexane, N,N-glycidyl-4-glycidyloxyaniline, sorbitol polyglycidyl ether, or glycerol polyglycidyl ether; an aldehyde based agent, such as formaldehyde, glutaric dialdehyde, succinic dialdehyde, or glyoxal; a blocked aldehyde agent, such as Curesan™ 200 from BASF Corp. (Mount Olive, N.J.), Cartabond TSI from Clariant Ltd. (Muttenz, Switzerland), and methylolmelamine; an active halogen based agent, such as 2,4-dichloro-4-hydroxy-1,3,5-s-triazine; an active vinyl based compound, such as 1,3,5-trisacryloyl-hexahydro-s-triazine or bisvinylsulfonyl methyl ether; an aluminum alum; an isocyanate compound; or a derivative thereof. The boric acid may include, but is not limited to, orthoboric acid, diboric acid, metaboric acid, tetraboric acid, pentaboric acid, octaboric acid, and salts thereof. Preferably, boric acid is used as the cross-linking agent. The amount of cross-linking agent present in the ink-receiving layer 4 may depend on the type of water-soluble polymer and inorganic particles that are used. It is contemplated that the cross-linking agent may be present from approximately 0.1% to approximately 5% based on the weight of the water-soluble polymer, such as PVOH.

The mordant used in the ink-receiving layer 4 may be a water-soluble compound that does not interact with the water-soluble polymer or the cross-linking agent. In addition, the mordant may not adversely impact the printing process. The mordant may be a cationic polymer, such as a polymer having a primary amino group, a secondary amino group, a tertiary amino group, a quaternary ammonium salt group, or a quaternary phosphonium salt group. The mordant may be in a water-soluble form or in a water-dispersible form, such as in latex. The water-soluble cationic polymer may include, but is not limited to, a polyethyleneimine; a polyallylamine; a polyvinylamine; a dicyandiamide-polyalkylenepolyamine condensate; a polyalkylenepolyamine-dicyandiamideammonium condensate; a dicyandiamide-formalin condensate; an addition polymer of epichlorohydrin-dialkylamine; a polymer of diallyldimethylammoniumchloride (“DADMAC”); a copolymer of diallyldimethylammoniumchloride-SO₂, polyvinylimidazole, polyvinylpyrrolidone; a copolymer of vinylimidazole, polyamidine, chitosan, cationized starch, polymers of vinylbenzyltrimethylammoniumchloride, (2-methacryloyloxyethyl)trimethyl-ammoniumchloride, and polymers of dimethylaminoethylmethacrylate; or a polyvinylalcohol with a pendant quaternary ammonium salt. Examples of the water-soluble cationic polymers that are available in latex form and are suitable as mordants are TruDot P-2604, P-2606, P-2608, P-2610, P-2630, and P-2850 (available from MeadWestvaco Corp. (Stamford, Conn.)) and Rhoplex® Primal-26 (available from Rohm and Haas Co. (Philadelphia, Pa.)). It is also contemplated that cationic polymers having a lesser degree of water-solubility may be used in the ink-receiving layer 4 by dissolving them in a water-miscible organic solvent.

A metal salt, such as a salt of an organic or inorganic acid, an organic metal compound, or a metal complex, may also be used as the mordant. For instance, since aluminum salts are inexpensive and provide the desired properties in the ink-receiving layer 4, an aluminum salt may be used. The aluminum salt may include, but is not limited to, aluminum fluoride, hexafluoroaluminate (for example, potassium salts), aluminum chloride, basic aluminum chloride (polyaluminum chloride), tetrachloroaluminate (for example, sodium salts), aluminum bromide, tetrabromoaluminate (for example, potassium salts), aluminum iodide, aluminate (for example, sodium salts, potassium salts, and calcium salts), aluminum chlorate, aluminum perchlorate, aluminum thiocyanate, aluminum sulfate, basic aluminum sulfate, aluminum sulfate potassium (alum), ammonium aluminum sulfate (ammonium alum), sodium sulfate aluminum, aluminum phosphate, aluminum nitrate, aluminum hydrogenphosphate, aluminum carbonate, polyaluminum sulfate silicate, aluminum formate, aluminum diformate, aluminum triformate, aluminum acetate, aluminum lactate, aluminum oxalate, aluminum isopropionate, aluminum butyrate, ethyl acetate aluminum diisopropionate, aluminum tris(acrylacetonate), aluminum tris(ethylacetoacetate), and aluminum monoacetylacetonate-bis(ethylaceto-acetate). Preferably, the mordant is a quaternary ammonium salt, such as a DADMAC derivative; an aluminum salt, such as aluminum triformate or aluminum chloride hydrate; or a cationic latex that includes quaternary ammonium functional groups, like TruDot P-2608. These are available from numerous sources, such as BASF Corp. (Mount Olive, N.J.), Ciba Specialty Chemicals (Basel, Switzerland), and MeadWestvaco Corp. (Stamford, Conn.).

While the Examples below describe coating compositions of the ink-receiving layer 4 as having a siloxane copolymer surfactant, mordant, cross-linking agent, inorganic particles, and organosilicone surfactant, it is understood that the ink-receiving layer 4 may include more than one of each of these components. For instance, the ink-receiving layer 4 may include a mixture of mordants, a mixture of cross-linking agents, or a mixture of organosilicone surfactants.

The coated paperbase 6, which is formed by conventional techniques, may be absorptive so that it is capable of absorbing water and humectants present in the ink vehicle. The coated paperbase 6 may include a coated paper (such as a calendared paper or an uncalendared paper), a cast-coated paper, or a commercial offset paper. As used herein, a coated paper is a paper having a coating that is formed with the previously described siloxane copolymer surfactant, which are applied to improve the paper's appearance and printability. The coating on the paperbase is believed to provide a smoother surface than plain paper, which contributes to the improved image quality and permanence of the printed image on the print medium 2.

The coating may include a wide variety of conventional coating formulations. For instance, the coating may be an aqueous dispersion ranging from approximately 50% to more than approximately 70% in total solids. Approximately 80% to approximately 90% of a dry formulation weight of the coating may be composed of pigments. Pigments are known in the art and may include china clay, which is available in several grades according to brightness and particle size. Other pigments may include barious sulfate, calcium carbonate, synthetic silicates, titanium dioxide, or plastic pigments. The plastic pigments, such as polystyrene, may be used in combination with other pigments to provide high gloss. A binder may be used to firmly cement particles of the pigment to the paper surface and to each other. When dried, the coating may be a porous structure of pigment particles cemented together at their points of contact rather than a continuous film. The binders may be glue, gums, casein, soya protein, starches, proteins, or synthetics emulsions based on styrene-butadiene, acrylic, or vinylacetate polymers. Representative coating components may be found in the Handbook For Pulp & Paper Technologist, G. A. Smook, Angus Wilde Publications, 2^{nd} Edition (1994), pp. 288, Table 18-3. Calendering may be performed on the coated papers to improve the gloss and smoothness of the paper. Id. at pp. 272-275. The calendered coated paper may include, but is not limited to, Ikono® Gloss 150 Paper, Mega® Matte 150 Paper, Ikono® Matte 200 paper, or Mega Gloss® 200 paper, which are commercially available from Zanders Feinpapiere AG (Finland).

Cast coating may also be used to produce the coated paperbase 6 having the desired gloss and smoothness. In cast coating, a wet coated paper may be pressed into contact with a large-diameter, highly glazed cylinder during the drying phase. The cast coated paperbase may include, but is not limited to, Chromolux® or Zanders Supergloss Paper, which are available from Zanders Feinpapiere AG (Finland).

To form the print medium 2, a coating composition of the ink-receiving layer 4 may be formed by combining the components to form a solution or dispersion, as known in the art. The coating composition may be applied to the coated paperbase 6 by a conventional coating technique, such as by roll coating, rod bar coating, air knife coating, spray coating, curtain coating, dip coating, roll coating, or extrusion techniques. The coating composition may then be dried on the coated paperbase 6 to form the ink-receiving layer 4 of the print medium 2.

The ink-receiving layer 4 may be coated on the coated paperbase 6 as a single layer. Due to the properties of the coated paperbase 6, such as its porosity, smoothness, and ink absorption rate, a very thin coating of the ink-receiving layer 4 may be used. As previously mentioned, the ink-receiving layer 4 may be a swellable (or polymeric) layer. In comparison to more expensive, photobased print media, images printed on a print medium of the present invention may exhibit better or equal image quality and permanence, such as light fastness and air fastness, and much improved humid bleed and humid color shift. These improved properties may be due, at least in part, to the siloxane copolymer surfactants and the absorptive paperbase used in the present invention.

A conventional inkjet ink and a conventional inkjet printer may be used to print the images on the print medium 2. The inkjet ink may include a dye or pigment as the colorant and other conventional components, such as water-soluble organic solvents, water, buffers, humectants, and surfactants. The printed images have reduced color bleed, humid bleed, haze, mottling, and improved lighffastness, golor gamut, and coalescence.

### EXAMPLES

The following examples illustrate that improved image quality and permanence are achieved using the print medium 2 having a layer of the ink-receiving layer 4, which includes a siloxane copolymer surfactant, with the coated paperbase 6. The following examples should not be considered as limitations of the present invention, but should be viewed as representative known embodiments and tests of the print medium based upon current experimental data.

Table 1 and 2 show general formulations of the ink-receiving layer 4 and the coated paperbase 6 used in the print media of the present invention. Table 2 shows the printing characteristics and image quality evaluation of various print media containing different siloxane and non-siloxane based nonionic surfactants on commercially available print media.

### Example 1

### Formulations of Coating Compositions Used in Surfactant Comparison

General formulations of each of the coating compositions tested are shown in Table 1. Each of the coating compositions was produced by mixing the listed components. The amount of each component in each of the coating compositions is listed as parts by weight, unless otherwise indicated. The percent of the surfactant was based on the total weight of the coating compositions. The percent solids of the coating compositions were from approximately 13% to approximately 15% (about 14% on average) solid. While the order of addition of the components was not critical, improved image quality was observed in formulations having the mordant mixed into the coating composition last.

The coating compositions were applied to Mega Gloss® coated and offset papers (all products of Zanders Feinpapiere AG) to form the ink-receiving layer 4 of the print media 2. Coating compositions 1-29 were applied to the coated paperbase 6 with a Mylar rod at approximately 5.5 GSM and allowed to dry.

TABLE I

| parts | Ingredient | Chemical |
|---|---|---|
| 60 | PVA | Mowiol 8-88 |
| 40 | PVA | Mowiol 15-79 |
| 5 | mordant (polyDAMMAC) | Agefloc WT35-VLV |
| 1.0 | crosslinker | Glyoxal |
| 1.5 | crossliner | Boric Acid |
| 10 | cationic colloidal silica | Ludox CL |
| 0.50% | nonionic surfactant | See table II |

### Example 2

### Image Quality Evaluation

To determine the image quality and printing characteristics of the print media, print samples were generated using a Hewlett-Packard DeskJet® 970 printer. Twenty-eight different samples were printed on print media having the coating compositions described in Example 1 with the surfactant being substituted with each of the various nonionic surfactants listed in Table II.

The haze uniformity (for each of composite black and for 100% cyan plus !00% magenta) and differential gloss were determined with a BYK GB-4535 gloss/haze meter by measuring the 20 degree gloss/haze of KCM squares at 50 and 100% saturation in comparison to the unimaged area. For the haze evaluation, the numbers were compiled and given a grading of A through D (with A being excellent and D being poor). For the differential gloss evaluation, a rating of good, fair, or poor was given for each sample. Mottling is the unevenness of the image after the print has dried for 24 hours. The mottle rating was made using composite black, determined by visual inspection, and given a grading of A through D, as with the haze evaluation.

TABLE II

| | | | | Haze | | |
|---|---|---|---|---|---|---|
| | | | Haze | 100% | Mottle | Differential |
| | | | composite | cyan/ | composite | Gloss |
| I.D. | Chemical | Type | black | Magenta | black | Imaged area |
| 1 | Silwet L-7605 | Siloxane-PEO | A | A | A | good |
| 2 | Silwet L-7220 | Siloxane-PEO-PPO | A | A | A | good |
| 3 | Silwet L-7650 | Siloxane-PEO | B | A | B | good |
| 4 | Silwet L-7607 | Siloxane-PEO | B | A | B | good |
| 5 | Silwet L-7600 | Siloxane-PEO | A | A | A | good |
| 6 | Silwet L-7602 | Siloxane-PEO | A | A | A | good |
| 7 | Silwet L-7644 | Siloxane-PEO | B | B | A | fair |
| 8 | Silwet L-7210 | Siloxane-PEO-PPO | A | A | A | good |
| 9 | Silwet L-7600 | Siloxane-PEO | A | A | A | good |
| 10 | BYK 307 | Siloxane-PEO-PPO | A | A | A | good |
| 11 | BYK 333 | Siloxane-PEO-PPO | A | A | A | good |
| 12 | Triton X-405 | Ethoxylated | B | A | B | good |
| | | Alkylphenol | | | | |
| 13 | Triton X-114 | Ethoxylated | B | B | B | fair |
| | | Alkylphenol | | | | |
| 14 | Pluronic 25R-4 | PPO-PEO-PPO | B | B | B | good |
| 15 | Pluronic L44 | PEO-PPO-PEO | B | B | B | fair |
| 16 | Tetronic 704 | PPO-PEO- | C | C | C | fair |
| | | ethylenediamine | | | | |
| 17 | Tetronic 90R4 | PPO-PEO- | C | C | C | fair |
| | | ethylenediamine | | | | |
| 18 | Surfynol 465 | Ethoxylated | D | D | D | fair |
| | | Acetylene | | | | |
| 19 | Surfynol 440 | Ethoxylated | D | D | D | fair |
| | | Acetylene | | | | |
| 20 | Surfynol 420 | Ethoxylated | D | D | D | fair |
| | | Acetylene | | | | |
| 21 | Triton X-100 | Ethoxylated | D | D | D | good |
| | | Alkelphenol | | | | |
| 22 | Tergitol 15-S-7 | C11-15 2ndary alc. | B | B | B | good |
| | | ethoxylates | | | | |
| 23 | Olin 10G | Polyglycol | B | B | B | good |
| 24 | Tween 20 | Ethoxylated Fatty | C | C | C | good |
| | | Acids | | | | |
| 25 | Tween 40 | Sorbitan | C | C | C | good |
| | | Derivatives | | | | |
| 26 | Tetronic 701 | PPO-PEO- | B | B | B | fair |
| | | ethylenediamine | | | | |
| 27 | Pluronic L10 | PEO-PPO-PEO | B | B | B | fair |
| 28 | Pluronic L35 | PEO-PPO-PEO | B | B | B | fair |

BYK® surfactants may be obtained from BYK Chemie (Abelstrasse, Germany). Triton® and Tergitol® surfactants may be obtained from Sigma-Aldrich Corp. (St. Louis, Mo.). Surfynol® surfactants may be obtained from Air Products and Chemicals, Inc. (Allentown, Pa.). Olin-10G® may be obtained from Olin Chemicals (Stamford, Conn.). Tween® surfactants are available from Uniquema (New Castle, Del.).

Table II shows that the print medium having a layer of the ink-receiving layer containing a siloxane copolymer surfactant demonstrated superior total image quality in comparison to print media having other types of nonionic surfactants (i.e., non-siloxane copolymer based surfactants).

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope thereof as defined by the following appended claims.

1. A print medium comprising an ink-receiving layer and a coated paperbase, the ink-receiving layer comprising a nonionic siloxane copolymer surfactant.

2. The print medium of claim 1, wherein the nonionic siloxane copolymer surfactant comprises the following structure: 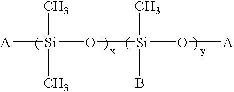
wherein A is —CH₃ or B, and B is a C₁ to C₁₀ straight chain or branched primary or secondary hydroxy terminated alkylene group, and x and y are such as to provide a molecular weight greater than about 1000.

3. The print medium of claim 1, wherein the nonionic siloxane copolymer surfactant comprises the following structure: 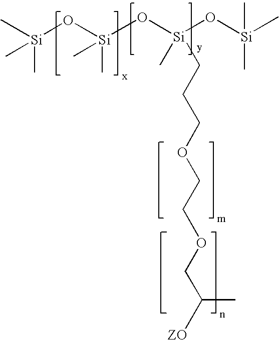
wherein m, n, x, and y are such as to provide a molecular weight greater than about 1000, wherein Z is H, —CH₃, or a C₁ to C₁₀ straight chain or branched primary or secondary hydroxy terminated alkylene group, and wherein the structure contains at least one polyethyleneoxide group.

4. The print medium of claim 1, wherein the surface tension of the nonionic siloxane copolymer surfactant is from about 20 dyne/cm to about 35 dyne/cm.

5. The print medium of claim 1, wherein the hydrophilic/hydrophobic balance value (HLB) of the nonionic siloxane copolymer surfactant is from about 10 to about 30.

6. The print medium of claim 1, wherein the weight percent (wt %) of the nonionic siloxane copolymer surfactant is from about 0.05 wt % to about 2 wt %.

7. The print medium of claim 1, wherein the nonionic siloxane copolymer surfactant has a molecular weight of greater than about 1000.

8. The print medium of claim 1, wherein the ink-receiving layer further comprises a nonionic or anionic surfactant, wherein the nonionic or anionic surfactant is present in a concentration that is less than the concentration of the nonionic siloxane copolymer surfactant present in the ink-receiving layer.

9. The print medium of claim 1, wherein the nonionic siloxane copolymer surfactant comprises at least one polysiloxane-polyethylene oxide compound or at least one polysiloxane-polyethylene oxide-polypropylene oxide compound.

10. The print medium of claim 1, wherein the coated paperbase comprises a coated paper, a cast-coated paper, or a commercial offset paper.

11. A method of forming a print medium having improved image quality and permanence, comprising:
providing a coated paperbase; and
applying an ink-receiving layer to the coated paperbase, the ink-receiving layer comprising a nonionic siloxane copolymer surfactant.

12. The method of claim 11, wherein applying an ink-receiving layer to the coated paperbase comprises applying a surfactant having the following structure: 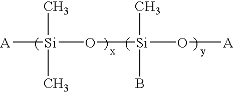
wherein A is —CH₃ or B, and B is a C₁ to C₁₀ straight chain or branched primary or secondary hydroxy terminated alkylene group, and x and y are such as to provide a molecular weight greater than about 1000.

13. The method of claim 11, wherein applying an ink-receiving layer to the coated paperbase comprises applying a surfactant having the following structure: 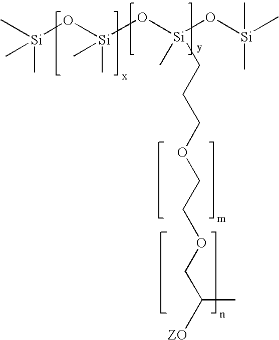
wherein m, n, x, and y are such as to provide a molecular weight greater than about 1000, wherein Z is H, —CH₃, or a C₁ to C₁₀ straight chain or branched primary or secondary hydroxy terminated alkylene group, and wherein the structure contains at least one polyethyleneoxide group.

14. The method of claim 11, wherein applying an ink-receiving layer to the coated paperbase comprises applying a nonionic siloxane copolymer surfactant having a molecular weight of greater than about 1000.

15. The method of claim 11, wherein applying an ink-receiving layer to the coated paperbase comprises applying a nonionic siloxane copolymer surfactant having at least one polysiloxane-polyethylene oxide compound or at least one polysiloxane-polyethylene oxide-polypropylene oxide compound.

16. A method of printing an image having improved image quality and permanence, comprising:
providing a print medium comprising a coated paperbase and an ink-receiving layer present on the coated paperbase, the ink-receiving layer comprising a nonionic siloxane copolymer surfactant; and
printing the image on the print medium.

17. The method of claim 16, wherein providing a print medium comprises providing an ink-receiving layer having a surfactant with the following structure: 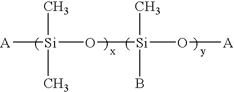
wherein A is —CH₃ or B, and B is a C₁ to C₁₀ straight chain or branched primary or secondary hydroxy terminated alkylene group, and x and y are such as to provide a molecular weight greater than about 1000.

18. The method of claim 16, wherein providing a print medium comprises providing an ink-receiving layer having a surfactant with the following structure: 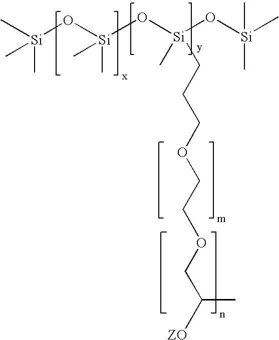
wherein m, n, x, and y are such as to provide a molecular weight greater than about 1000, wherein Z is H, —CH₃, or a C₁ to C₁₀ straight chain or branched primary or secondary hydroxy terminated alkylene group, and wherein the structure contains at least one polyethyleneoxide group.

19. The method of claim 16, wherein providing a print medium comprises providing an ink-receiving layer having a nonionic siloxane copolymer surfactant with a molecular weight of greater than about 1000.

20. The method of claim 16, wherein providing a print medium comprises providing an ink-receiving layer having at least one polysiloxane-polyethylene oxide compound or at least one polysiloxane-polyethylene oxide-polypropylene oxide compound.
